(19) United States
(12) Patent Application Publication
(10) Pub. No.: US 2016/0138666 A1
(43) Pub. Date: May 19, 2016

(54) Micromechanical spring for an inertial sensor

(71) Applicant: Robert Bosch GmbH, Stuttgart (DE)

(72) Inventors: Christian HOEPPNER, Stuttgart (DE); Benjamin Schmidt, Stuttgart (DE); Mirko Hattass, Stuttgart (DE); Odd-Axel Pruetz, Nuertingen (DE); Robert Maul, Pforzheim (DE); Friedjof Heuck, Stuttgart (DE); Rolf Scheben, Reutlingen (DE); Torsten Ohms, Vaihingen/Enz-Aurich (DE); Reinhard Neul, Stuttgart (DE)

(21) Appl. No.: 14/924,135

(22) Filed: Oct. 27, 2015

(30) Foreign Application Priority Data
Nov. 14, 2014 (DE) 10 2014 223 329.1

(51) Int. Cl. F16F 1/02; G01C 19/56

(52) U.S. Cl. CPC F16F 1/021; G01C 19/56; F16F 2224/02; F16F 2226/00; F16F 2230/0047; F16F 2238/02

(57) ABSTRACT

A micromechanical spring for an inertial sensor, including segments of a monocrystalline base material, the segments having surfaces which are situated at a right angle to one another with respect to a plane of oscillation of the spring and normal to the plane of oscillation of the spring, the segments being manufactured in a crystal-direction-dependent etching process and each having two different orientations normal to the plane of oscillation, in which the spring includes a defined number of segments situated in a defined manner.

### RELATED APPLICATION INFORMATION

The present application claims priority to and the benefit of German patent application no. 10 2014 223 329.1, which was filed in Germany on Nov. 14, 2014, the disclosure of which is incorporated herein by reference.

### FIELD OF THE INVENTION

The present invention relates to a micromechanical spring for an inertial sensor. The present invention further relates to a method for manufacturing a micromechanical spring for an inertial sensor.

### BACKGROUND INFORMATION

The technology for manufacturing inertial sensors using microsystems engineering (for example, rotation rate sensors) has made great progress and allows for structures having very narrow tolerances to be configured.

To satisfy the high requirements for sensitivity and robustness of the rotation rate sensor, the correction of a flank misorientation angle in the MEMS and ASIC design demands a high degree of complexity and chip surface. The flank misorientation angle is understood to be a parallel tipping of side walls of a spring structure or a deviation of the side walls from a surface normal. The flank misorientation angle represents a critical error (parallelogram error), which primarily has an effect on the so-called “quadrature,” which disadvantageously effectuates an error signal coupled into the detection caused by an actuation of the rotation rate sensor. The error signal materializes due to a movement of sub-structures of the seismic mass effectuated by a Coriolis force. A compensation of the above-named error signals is only possible using great circuit-wise complexity, for example, by providing voltages on the ASIC.

Patent document DE 10 2012 218 845 A1 discusses a manufacturing method for a micromechanical component and a micromechanical component. Here, an at least partial structuring of at least one structure from initially one monocrystalline silicon layer is carried out by carrying out at least one crystal-orientation-dependent etching step on a surface of the silicon layer at a given 110-surface orientation of the silicon layer, at least one crystal-orientation-independent etching step being additionally carried out on the upper side of the silicon layer at the given 110-surface orientation of the silicon layer for the at least partial structuring of the at least one structure.

Micromechanical sensors are becoming increasingly smaller and more powerful, making it no longer possible to satisfy the extreme requirements using spring elements manufactured with the aid of plasma etching.

### SUMMARY OF THE INVENTION

One object of the present invention is therefore to provide an improved micromechanical spring for an inertial sensor.

According to a first aspect, the object is achieved using a micromechanical spring for an inertial sensor including: Segments of a monocrystalline base material, the segments having surfaces which are situated at a right angle to one another with respect to a plane of oscillation of the spring and normal to the plane of oscillation of the spring, the segments being manufactured in a crystal-direction-dependent etching process and each having two different orientations normal to the plane of oscillation, characterized in that the spring includes a defined number of segments situated in a defined manner.

In this way, a manufacturing process, which is known per se, is used for manufacturing segments for the micromechanical spring. The crystal-direction-dependent etching process produces side walls which are formed very exactly perpendicularly to one another in the plane of oscillation and normal to it, essentially eliminating the quadrature error of inertial sensors having the springs according to the present invention. As a result, a very defined sensing characteristic of such an inertial sensor is supported.

According to a second aspect, the object is achieved using a method for manufacturing a micromechanical spring for an inertial sensor, including the steps:
providing a monocrystalline base material;
forming segments in the base material, surfaces which are situated perpendicularly to one another being formed in the segments using a crystal-direction-dependent etching process with respect to a plane of oscillation and normal to the plane of oscillation of the spring, each of the segments in the plane of oscillation having two different orientations; and
approximating the spring by a defined positioning of a defined number of the segments.

Refinements of the micromechanical spring are the subject matter of the further descriptions herein.

A refinement of the micromechanical spring is characterized in that the base material is silicon, the segments being manufactured with the aid of a wet chemical etching method using KOH as the etching medium. In this way, a method proven in the MEMS technology is used for manufacturing the perpendicular side walls of the spring elements. One advantage of the wet chemical structuring is a simple design of an etching chamber as well as a very high homogeneity of an etching rate across the entire wafer. Since the process is a wet chemical process, problems are eliminated, for example, the parallax problem of dry plasma etching (deep reactive ion etching, DRIE). Furthermore, it is possible to work with thinner masks and etch stops and transitions are better defined in wet chemical etching than in dry etching. Moreover, wafers may be processed stack-wise instead of in a single wafer process in plasma etching.

One advantageous refinement of the micromechanical spring is characterized in that the silicon has a 110-crystal orientation. Thus, a base material of such a type is used that produces very well-defined perpendicular side walls using wet chemical etching. The use of a monocrystalline layer results in well-defined crystal planes. These may be etched using suitable wet chemical etching methods having extremely high selectivity to one another; moreover, the chemical selectivity is far superior to the physical selectivity of dry plasma etching. If a silicon layer having a 110-surface orientation is used, the 111-crystal planes lie perpendicularly to the 110-surface. Due to a high selectivity in relation to the other planes, these 111-planes are hardly etched, making it possible to produce perpendicular side walls in this way. The error angle in this method is primarily defined by a precise setting of the surface to the 110-plane. Error angles are advantageously smaller than approximately 0.01°.

One refinement of the spring is characterized in that the spring may be implemented as a U-, L-, S-, conductor spring, meander spring or combinations thereof. In this way, a high level of design flexibility is supported in designing the micromechanical spring.

One refinement of the method is characterized in that a design of the spring device is carried out in a lithographic layout process. In this way, a complete design of the spring may be established in advance in one single step, making subsequent monolithic processing of the spring possible.

The present invention is described in detail below to include additional features and advantages based on multiple drawings. Here, all described features constitute the object of the present invention irrespective of their presentation in the description and in the drawings or irrespective of their back-reference in the patent claims. The drawings are in particular intended to illustrate the principles essential to the present invention and have not necessarily been carried out true to scale.

### BRIEF DESCRIPTION OF THE DRAWINGS

FIG. 1a shows a diagram of orientations in the sense of the present invention.

FIG. 1b shows an inertial sensor having a micromechanical spring.

FIG. 2 shows a first specific embodiment of the micromechanical spring according to the present invention.

FIG. 3 shows another specific embodiment of the micromechanical spring according to the present invention.

FIG. 4 shows an inertial sensor having a spring according to the present invention.

### DETAILED DESCRIPTION

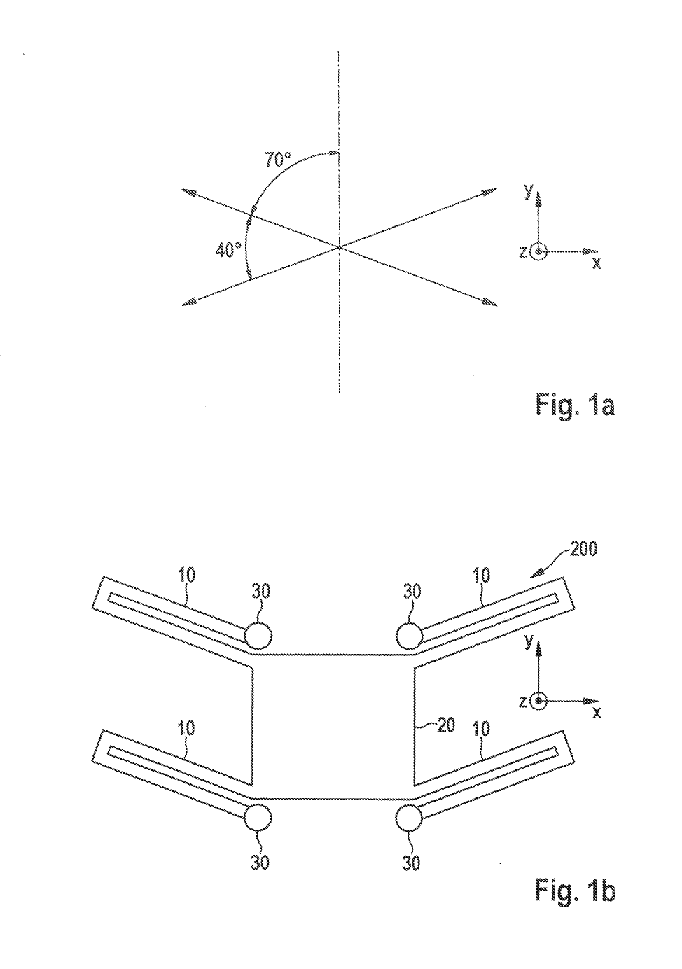

FIG. 1a shows a schematic view of the system of 111-Si-crystal surfaces, which were formed according to a wet chemical etching process and which in result are oriented in relation to one another at an angle of approximately 70° or approximately −40°. The partial directions correspond to the orientations of segments 10 described below. For the purpose of illustration, a Cartesian coordinate system is shown in FIG. 1a, an x-y plane corresponding to a plane of oscillation of the spring described below. It is, however, self-evident that the selection of the coordinates of FIG. 1a is only used for establishing an orientation in space. An alternative coordinate system, in which the x-, y- and z-coordinates are interchanged accordingly, is therefore also possible.

Based on the above-described processing and the use of the 111-plane of the silicon as a side wall of the critical springs, it follows that all critical spring structures are oriented with respect to one another at an angle of approximately 70°. This has the result that, if they have classic spring forms (for example, U-, S-, L-, meander spring or conductor spring), such springs have unfavorable angles to the seismic masses, which are suspended on them.

FIG. 1b shows an unfavorable system of an inertial sensor 200 of this type having a seismic mass 20 and segments 10, which are formed according to the orientations described in FIG. 1a. Segments 10 are fixedly connected to seismic mass 20 with the aid of fixed connections 30. It is apparent that a movement of inertial sensor 200 in the plane of oscillation (x-y plane) implements an unfavorable oscillation behavior; in particular, no translational movements of an exact nature may be generated using an inertial sensor 200 of this type. Due to the limitation to angles of 70° or 110°, it is no longer possible to measure rotations in the plane about the x-axis and about the y-axis orthogonally to one another. This means for the case that a rotation is to be determined about only a single axis using such a sensor, in principle, both channels must be measured and the rotation must be calculated back.

It is therefore provided to form segments 10 of a spring 100 initially in one crystal-direction-dependent etching process. This may be formed as a wet chemical etching using KOH (potassium hydroxide or caustic potash) as the etching medium, a monocrystalline silicon having a 110-orientation being provided as base material. As a result, the 111-planes of the silicon are thus essentially not etched, thus making it possible to provide surfaces of the Si base material formed very exactly perpendicularly to one another as a result, with respect to the oscillation plane and perpendicular to it. Due to factors related to processing, the above-named 111-planes are situated within the plane of oscillation exclusively in a ±70°/±40° orientation to one another.

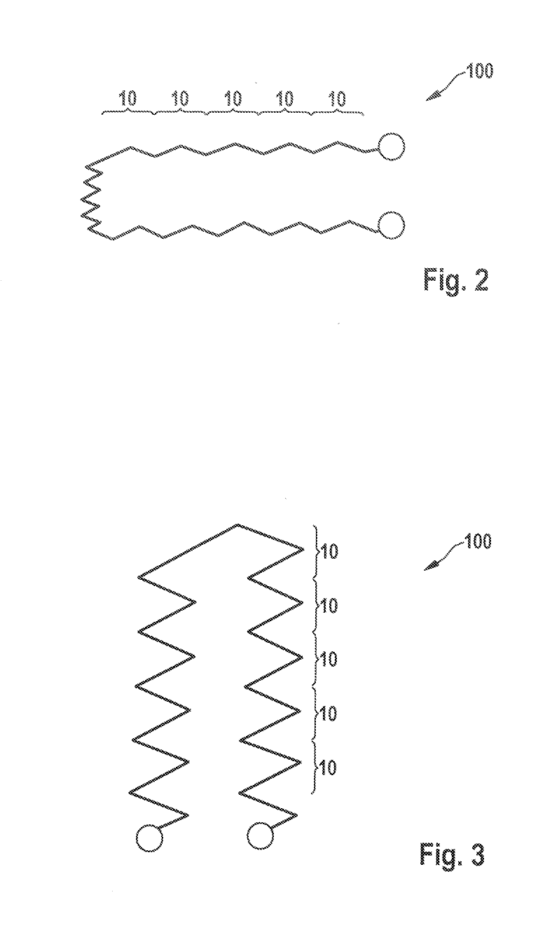

Subsequently, springs 100 are formed in an approximate manner by stringing together individual segments 10. For example, apparent in FIG. 2 is a micromechanical U-spring manufactured in such a way, which has been approximated with the aid of multiple segments 10. As a result, an “assembled” micromechanical spring 100 results from a type of zig-zag structure of segments 10. FIG. 2 shows such an approximation, the approximated partial directions resulting in an essentially horizontally oriented U-spring.

FIG. 3 shows another example of a specific embodiment of spring 100 according to the present invention made up of individual segments 10. Here also, individual segments 10 have exclusively two spatial directions, namely −70° and +70°.

As a result, this makes it possible to implement an essentially vertically oriented U-spring.

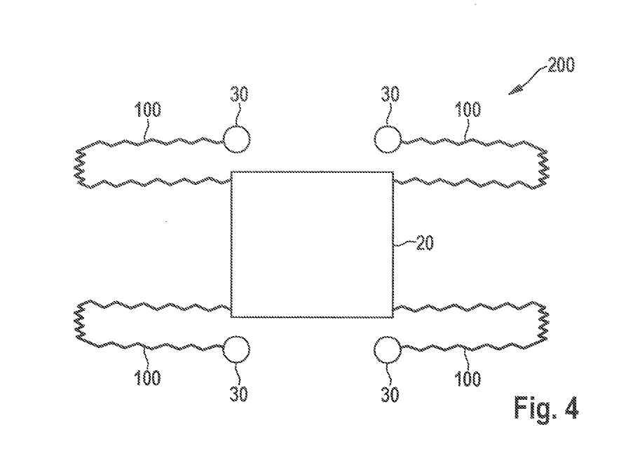

FIG. 4 shows an inertial sensor 200 having a seismic mass 20 and four springs 100, which are oriented essentially orthogonally in relation to seismic mass 20.

Advantageously, the provided approximation of segments 10 may be used to implement any arbitrary orientation of springs 100 with respect to seismic mass 20. Due to the fact that segments 10 have essentially no flank misorientation angle, as a result, a very readily reproducible and reliable sensing behavior of a micromechanical sensor is supported using springs 100. In particular, this makes it possible to completely avoid or greatly reduce the quadrature error, whereby complex measures for its suppression or compensation may be dispensed with.

Advantageously, any spring structures, for example, U-, L-, S-, conductor springs, meander springs or combinations thereof may be implemented using the provided approximation. This advantageously supports great freedom of design for micromechanical springs 100.

Advantageously, the present invention makes it possible to achieve an improvement in the direction of robust inertial sensors having a reduced complexity of the MEMS and ASIC design and a further limitation of the tolerances, which is achieved in particular by eliminating or greatly reducing the flank misorientation angle across the entire wafer.

Advantageously, the individual crystallographic-related partial directions (±70° or ±40°) of segments 10 may be formed of any length with respect to processing, for example, from several tens of micrometers to several hundreds of micrometers, making it advantageously possible to design a plurality of spring forms in a CAD-supported layout design process. Using already known exposure, etching and epitaxy processes, it is then possible to implement these spring forms technically.

Spring-mass systems of the rotation rate sensor are manufactured, for example, using known anisotropic microstructuring methods, which are known per se. The nearly perpendicular side walls of the springs thus formed play a decisive role in the movement of the oscillators in the plane. Only close tolerances allow a small design window of the spring stiffness, since these are included at the third power for the horizontal moment of inertia or horizontal spring stiffness. In particular the flank misorientation angle, i.e., the parallel tipping of the side walls or the deviation of the side walls from a surface normal, and in particular their difference in this connection, is a critical error (parallelogram error).

In summary, arbitrary spring structures having a very small error angle tolerance are approximated using spring segments having surfaces which are oriented in defined directions to one another. A stringing together of multiple parts carried out in a layout makes it possible to approximate basic forms in all arbitrary directions via zig-zag patterns of surfaces which are perpendicular to one another. The quadrature-free or greatly quadrature-reduced structures thus make it possible to manufacture powerful sensor circuits on a small area cost-effectively.

This makes it possible to replicate designs already developed in conventional processing in a relatively simple manner. Likewise, significantly greater freedom of design is, of course, also possible for all novel designs, since one is no longer bound to the ±70°/±40° orientation of the spring segments.

In particular a so-called omega X rotation rate sensor has been described above, i.e., a rotation rate sensor whose seismic mass oscillates in-plane, out-of-plane deflections of the mass being detected. Of course, the principle according to the present invention is also applicable for other inertial sensors having other sensing principles.

Although the present invention has been described above based on specific embodiments, it is not limited thereto. Those skilled in the art will thus implement specific embodiments not described or only partially described above without departing from the core of the present invention.

What is claimed is:

1. A micromechanical spring for an inertial sensor, comprising:
segments of a monocrystalline base material, the segments having surfaces which are situated at a right angle to one another with respect to a plane of oscillation of the spring and normal to the plane of oscillation of the spring, the segments being manufactured in a crystal-direction-dependent etching process and each having two different orientations normal to the plane of oscillation; and
a defined number of segments situated in a defined manner.

2. The micromechanical spring of claim 1, wherein the base material is silicon, the segments being manufactured with the aid of a wet-chemical etching method using KOH as the etching medium.

3. The micromechanical spring of claim 2, wherein the silicon has a 110-crystal orientation.

4. The micromechanical spring of claim 1, wherein the spring is implemented as a U-, L-, S-, conductor spring, meander spring or combinations thereof.

5. A method for manufacturing a micromechanical spring for an inertial sensor, the method comprising:
providing a monocrystalline base material;
forming segments in the base material, surfaces which are situated perpendicularly to one another being formed in the segments using a crystal-direction-dependent etching process with respect to a plane of oscillation and normal to the plane of oscillation of the spring, each of the segments in the plane of oscillation having two different orientations; and
approximating the spring by a defined positioning of a defined number of the segments.

6. The method of claim 5, wherein a design of the spring device is carried out in a lithographic layout process.

7. The method of claim 5, wherein a wet chemical etching using KOH as the etching medium is carried out as a crystal-direction-dependent etching process.

8. The method of claim 7, wherein the wet chemical etching is carried out using silicon having a 110-crystal orientation.

9. The micromechanical spring of claim 1, wherein the spring is used in an inertial sensor.
